(19) United States
(12) Patent Application Publication
(10) Pub. No.: US 2013/0159597 A1
(43) Pub. Date: Jun. 20, 2013

(54) HYBRID STORAGE DEVICE AND METHOD OF OPERATING THE SAME

(71) Applicant: Electronics and Telecommunications Research In, Daejeon (KR)

(72) Inventor: Seung Kook CHEONG, Daejeon (KR)

(73) Assignee: Electronics and Telecommunications Research Institute, Daejeon (KR)

(21) Appl. No.: 13/660,496

(22) Filed: Oct. 25, 2012

(30) Foreign Application Priority Data
Dec. 19, 2011 (KR) 10-2011-0137379

(51) Int. Cl. G06F 12/02; G06F 12/08

(52) U.S. Cl. 711/102; 711/165; 711/118; 711/E12.002; 711/E12.008; 711/E12.017

(57) ABSTRACT

The inventive concept herein relates to data storage devices, and more particularly, to a hybrid storage device including a plurality of storage media. The hybrid storage device may include first and second storage media storing a plurality of data blocks according to a data type and a hybrid controller configured to copy a data block having a change type to the first storage medium if a data type of the data block stored in the second storage medium is changed.

### CROSS-REFERENCE TO RELATED APPLICATIONS

This U.S. non-provisional patent application claims priority under 35 U.S.C. §119 of Korean Patent Application No. 10-2011-0137379, filed on Dec. 19, 2011, the entire contents of which are hereby incorporated by reference.

### BACKGROUND

The present inventive concept herein relates to data storage devices, and more particularly, to a hybrid storage device including a plurality of storage media.

Semiconductor memories are memory devices embodied using semiconductor such as silicon (Si), germanium (Ge), gallium arsenic (GaAs), indium phosphide (InP), etc. The semiconductor memories are classified into volatile memories and nonvolatile memories. The volatile memories lose their stored data when their power supplies are interrupted. Examples of the volatile memories are a static RAM (SRAM), a dynamic RAM (DRAM), a synchronous DRAM (SDRAM), etc. The nonvolatile memories maintain their stored data even when their power supplies are interrupted. Examples of the nonvolatile memories are a read only memory (ROM), a programmable ROM (PROM), an electrically programmable ROM (EPROM), an electrically erasable and programmable ROM (EEPROM), a flash memory, a phase change RAM (PRAM), a magnetic RAM (MRAM), a resistive RAM (RRAM), a ferroelectric RAM (FRAM), etc.

A hard disk drive (HDD) includes a platter in which data is recorded, a spindle motor rotating a platter and a head reading and writing data. When data is stored in the hard disk drive (HDD), the spindle motor rotates the platter. The head records data in the rotating platter.

A hybrid storage device including a semiconductor memory and a hard disk drive may be embodied to provide high performance with a comparatively low price.

### SUMMARY

Embodiments of the inventive concept provide a hybrid storage device. The hybrid storage device may include first and second storage media in which a plurality of data blocks having a data type of hot data or cold data is stored according to the data type; and a hybrid controller which is configured to copy the data block having a changed data type to the first storage medium if the data type of the data block stored in the second storage medium is changed. When the data type of the data block copied to the first storage medium is changed again and the data block copied to the first storage medium is not updated, the hybrid controller is configured to skip an operation that the copied data block is recopied to the second storage medium.

Embodiments of the inventive concept also provide an operation method of hybrid storage device including first and second storage media. The operation method may include storing a plurality of data blocks in the first and second storage media according to data types of the plurality of data blocks; and copying data block of changed data type to the first storage medium if data type of data block stored in the second storage medium is changed. When the data type of data block copied to the first storage medium is changed again and the data block copied to the first storage medium is not updated, an operation that the copied data block is recopied to the second storage medium is omitted.

### BRIEF DESCRIPTION OF THE FIGURES

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

FIG. 1 is a block diagram illustrating a hybrid storage device in accordance with some embodiments of the inventive concept.

FIG. 2 is a block diagram illustrating a hybrid storage device of the case that first and second storage media of FIG. 1 are a solid state drive and a hard disk drive respectively.

FIG. 3 is a block illustrating a hybrid controller of FIG. 1 in more detail.

FIG. 4 is a drawing illustrating a solid state drive and a hard disk drive.

FIG. 5 is a flow chart illustrating an operation method of hybrid storage device in accordance with some embodiments of the inventive concept.

FIGS. 6 and 7 are drawings for explaining an operation method of hybrid storage device.

### DETAILED DESCRIPTION OF THE EMBODIMENTS

Embodiments of inventive concepts will be described more fully hereinafter with reference to the accompanying drawings, in which embodiments of the invention are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

A hybrid storage device in accordance with some embodiments of the inventive concept monitors a read request and a write request from a host to collect information on an access frequency and access time to a logical block and measures a temperature (hot, cold) by logical blocks on the basis of the information. The hybrid storage device stores a hot data block in a first storage medium (e.g., DDR-SSD) and stores a cold data block in a second storage medium (e.g., HDD).

A hybrid storage device 2000 in accordance with some embodiments of the inventive concept monitors whether or not a data block stored in a hard disk drive 2300 becomes a hot data block and a data block stored in a solid state drive 2200 becomes a cold data block. The hybrid storage device 2000 moves a corresponding data block between the solid state drive 2200 and the hard disk drive 2300 according to a monitoring result.

To minimize a cost of movement data blocks stored in the first and second storage media, a cashing and a duplicating are applied.

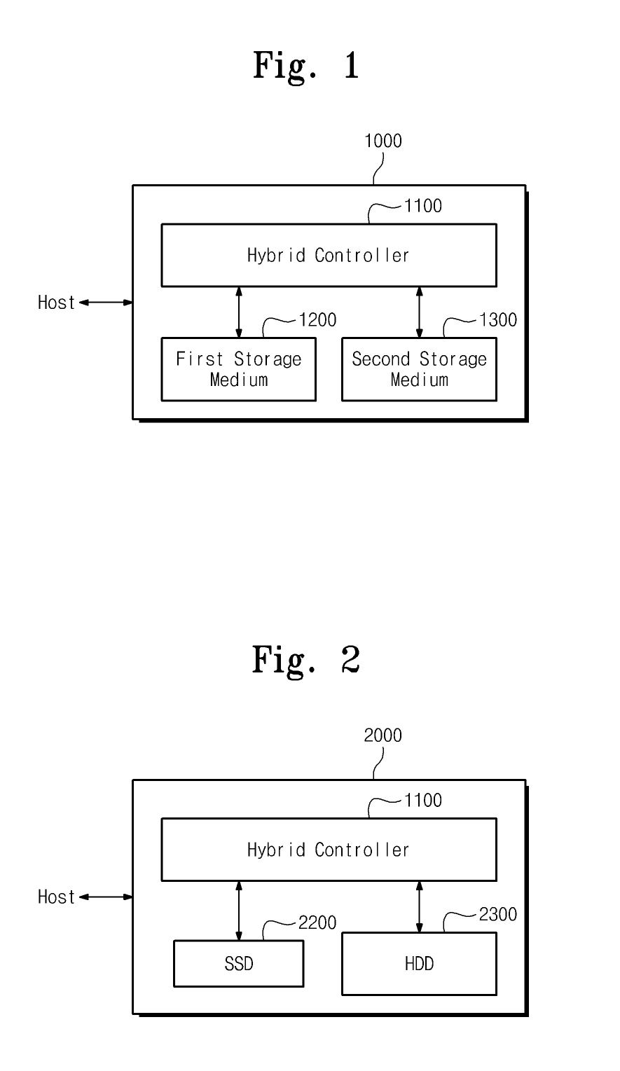

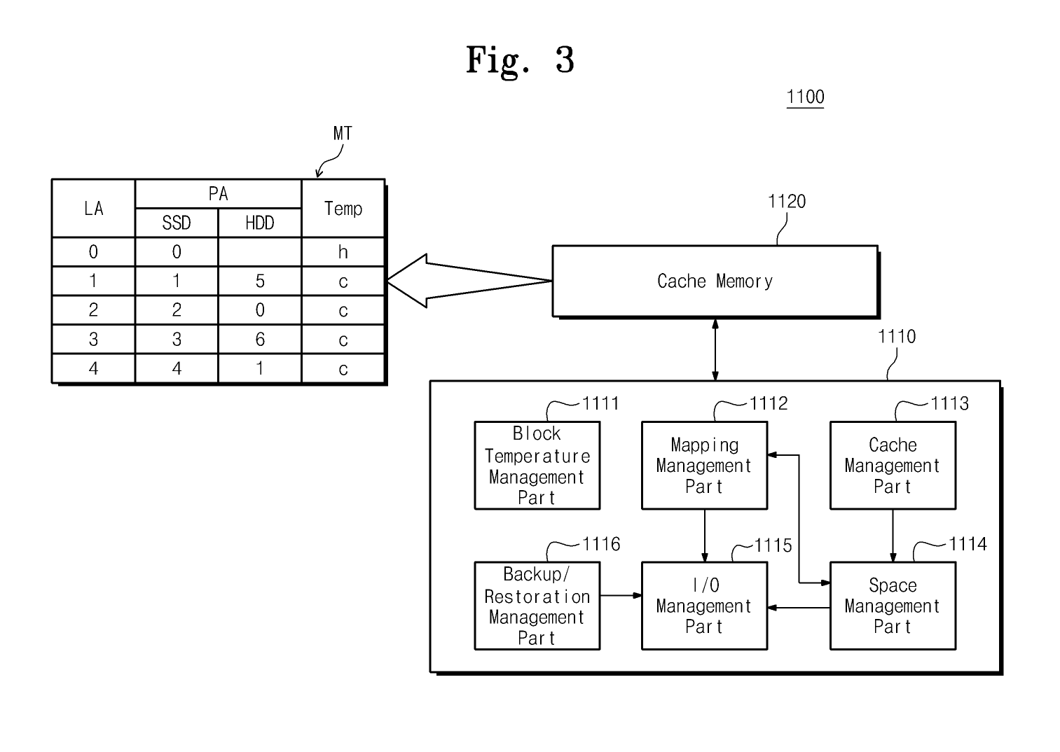

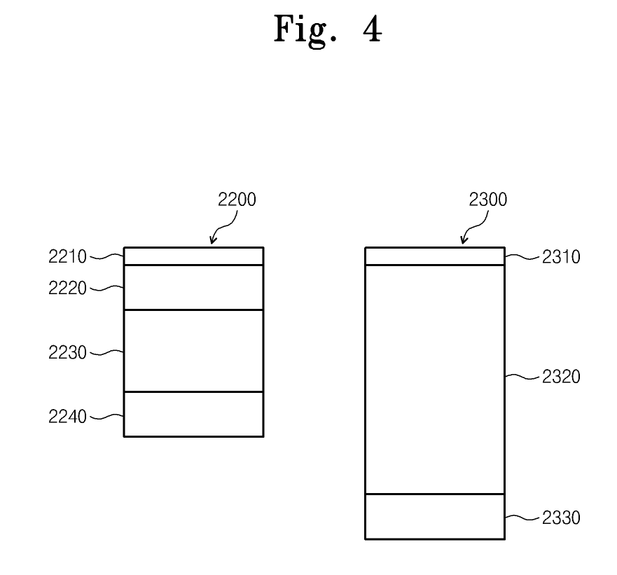

FIG. 1 is a block diagram illustrating a hybrid storage device 1000 in accordance with some embodiments of the inventive concept. FIG. 2 is a block diagram illustrating a hybrid storage device of the case that first and second storage media 1200 and 1300 of FIG. 1 are a solid state drive 2200 and a hard disk drive 2300 respectively. FIG. 3 is a block illustrating a hybrid controller 1100 of FIG. 1 in more detail.

Referring to FIG. 1, the hybrid storage device 1000 includes a hybrid controller 1100, a first storage medium 1200 and a second storage medium 1300. The hybrid storage device 1000 is configured to store data blocks received from a host, read data blocks in the hybrid storage device 1000 and erase data blocks in the hybrid storage device 1000.

The data block means data corresponding to each logical block which is unit of logical block address. The data block means data corresponding to each physical block which is unit of physical block address.

The hybrid controller 1100 is connected to the first and second storage media 1200 and 1300. The hybrid controller 1100 is configured to control an overall operation of the hybrid storage device 1000. The hybrid controller 1100 may be the interface between the first and second storage media 1200 and 1300 and the host.

The first and second storage media 1200 and 1300 are connected to the hybrid controller 1100. The first and second storage media 1200 and 1300 operate in response to a control of the hybrid controller 1100. The first and second storage media 1200 and 1300 may have different characteristics. For instance, the whole storage space of the second storage medium 1300 is greater than the whole storage space of the first storage medium 1200. An operation speed (e.g., a read, write or erase speed) of the first storage medium 1200 is higher than an operation speed of the second storage medium 1300. The first and second storage media 1200 and 1300 may be constituted by various storage units such as a nonvolatile memory, a volatile memory and a hard disk drive.

Referring to FIG. 2, the first storage medium 1200 may be a solid state drive (SSD) 2200 and the second storage medium 1300 may be a hard disk drive (HDD) 2300. The first storage medium 1200 may be a solid state drive (DDR-SSD) 2200 including a DRAM which is a volatile memory. The solid state drive 2200 provides a higher operation speed than the hard disk drive 2300 while a storage space of the hard disk drive 2300 is greater than a storage space of the solid state drive 2200. Assume that the first storage medium 1200 is the solid state drive 2200 and the second storage medium 1300 is the hard disk drive 2300. However, the inventive concept is not limited thereto.

Referring to FIG. 3, the hybrid controller 1100 includes a controller 1110 and cache memory 1120. The controller 1110 and the cache memory 1120 are electrically connected to each other.

The controller 1110 includes a block temperature management part 1111, a mapping management part 1112, a cache management part 1113, a space management part 1114, an I/O management part 1115 and a backup/restoration management part 1116.

The block temperature management part 1111 monitors I/O of all logical blocks to judge a type (i.e., hot data or cold data) of data block corresponding to each logical block by various methods such as checking the number of reads and writes of each logical block and checking the frequency of read and write of each logical block. The type of data block corresponding to each logical block is recorded in a mapping table MT.

The mapping management part 1112 records a mapping relation between a logical block address LA and a physical block address PA in the mapping table MT. That is, the mapping management part 1112 stores physical block information corresponding to each logical block in a unit of each logical block. The mapping management part 1112 can record whether or not data block stored in the solid state drive 2200 is updated or changed as a flag corresponding to the corresponding logical block in the mapping table MT.

According to some embodiments of the inventive concept, the mapping management part 1112 judges whether the data type of data block stored in the hybrid storage device 2000 is changed with reference to a temperature field of the mapping table MT. The mapping management part 1112 judges whether data block having a changed type is doubly stored in the solid state drive 2200 and the hard disk drive 2300 with reference to the mapping table MT. In the case that the corresponding data block is doubly stored, the hybrid controller 1100 skips a copy operation of the corresponding data block.

In the mapping table MT illustrated in FIG. 3, a physical block corresponding to each logical block is recorded. For convenience of cognition, only information about 0 through 4 logical blocks is expressed in the mapping table MT of FIG. 3. The mapping table MT includes physical block information in the solid state drive 2200 corresponding to each logical block and physical block information in the hard disk drive 2300 corresponding to each logical block. A type of data block corresponding to each logical block is recorded in the mapping table MT. In the mapping table MT of FIG. 3, “h” means a hot data block and “c” means a cold data block.

The cache management part 1113 manages the cache memory 1120. The cache management part 1113 stores a data block read from each of storage medium and a data block to be written in each storage medium in the cache memory 1120. The cache memory 1120 is used as a buffer memory between the outside, and the solid state drive 2200 and the hard disk drive 2300. A storage capacity of the cache memory 1120 is fixed. When the cache memory 1120 cannot store data any more, the cache memory 1120 removes a part of data block and stores a new data block according to a proper change policy. According to some embodiments of the inventive concept, criterion of movement is newly assigned by a logical block and a space is obtained by changing a data block of logical block having the lowest movement.

In FIG. 3, the cache memory 1120 is illustrated to be a constituent element of the hybrid controller 1110. However, this is an illustration and the inventive concept is not limited thereto.

To move a data block stored in each storage medium to a different storage medium, assume that operations are performed that a data block stored is read from the storage medium 2200 or 2300, the data block read is stored in the cache memory 1120 and a data block temporarily stored in the storage medium 2200 or 2300 is written. Those operations take a long time and if the large amount of data blocks moves at a specific time, an input output per second (IOPS) of the hybrid storage device 2000 is deteriorated. The cache management part 1113 maintains a data block having a high possibility of movement between storage media in the cache memory 1120. The cache management part 1113 performs only a data block write operation if a data block is stored in the cache memory 1120 when movement of data block is required.

The cache management part 1113 manages a movement value corresponding to each data block stored in the cache memory 1120. The movement value managed by the cache management part 1113 is stored in the cache memory 1120. The movement value is distinguished according to a temperature of data block (type of data block) distinguished by the block temperature management part 1111 and whether a storage medium storing the data block is the solid state drive 2200 or the hard disk drive 2300. If a temperature of data block stored in the hard disk drive 2300 becomes high and the data block is distinguished to be a hot data block, the movement value will increase. If a temperature of data block stored in the solid state drive 2200 becomes low and the data block is distinguished to be a cold data block, the movement value will increase.

The space management part 1114 manages free data blocks (i.e., a storage space not used) of the hybrid storage device 2000. The space management part 1114 assigns a physical block in which a data block will be stored when a data block moves between storage media and a write operation of data block from a host is performed. A mapping relation between a logical block and an assigned physical block is stored in the mapping table MT inside the cache memory 1120 by the mapping management part 1112.

The I/O management part 1115 stores a data block in an area which a physical block assigned by the space management part 1114 indicates. The I/O management part 1115 receives physical block information corresponding to a logical block received from the host and the mapping management part 1112 when a read operation is performed. The I/O management part 1115 reads a data block of an area which a physical block indicates according to the received physical block. When a movement of a hot data block and a cold data block between storage media is performed, the I/O management part 1115 controls each storage medium to perform a read and write operations of the data block.

According to some embodiments of the inventive concept, when a data block moves between storage media, an original data block of storage medium remains the same. When the remaining space more than certain amount exists in a storage medium in which an original data block is stored, the original data block may selectively remain.

Assume that a specific data block of the hard disk drive 2300 is judged to be a hot data block and the judged hot data block moves to the solid state drive 2200. At this time, a corresponding original data block remains in the hard disk drive 2300. That is, the original data block stored in the hard disk drive 2300 is copied to the solid state drive 2200. Assume that a specific data block of the solid state drive 2200 is judged to be a cold data block and the judged cold data block moves to the hard disk drive 2300. At this time, a corresponding original data block remains in the solid state drive 2200. The original data block stored in the solid state drive 2200 is copied to the hard disk drive 2300. Consequently, data blocks double-stored in each storage medium exist. According to some embodiment of the inventive concept, overlap of data blocks contributes to reduce a movement time of data block between storage media. The overlap will be recorded in the mapping table MT. In the case of read only data blocks and they are double-stored in the storage media, even if a state is change from a hot data block to a cold data block, the read-only data block does not move between storage media.

The backup/restoration management part 1116 performs a function of safely managing data blocks in the hybrid storage device 2000 even though a power supply of the hybrid storage device 2000 is cut off. The backup/restoration management part 1116 detects that a power supply provided to the hybrid storage device 2000 is cut off. After the power supply is cut off, for example, after predetermined time passed after power down, the backup/restoration management part 1116 transmits a control signal for movement of data blocks stored in the solid state drive 2200 to the mapping management part 1112. The mapping management part 1112 distinguishes the data blocks stored in the solid state drive 2200 with reference to the mapping table MT and moves the distinguished data block to the hard disk drive 2300.

Assume that the solid state drive 2200 is a solid state drive including a DRAM (hereinafter it is referred to as DDR-SSD). A DRAM is a volatile memory. If power supply is cut off and batteries of the hybrid storage device 2000 are all consumed, the solid state drive 2200 loses its stored data. In this case, data blocks of the solid state drive 2200 will safely move to the hard disk drive 2300. That is, data blocks of the solid state drive 2200 will be backed up. If assuming that capacity of data blocks stored in the solid state drive 2200 is several hundred gigabytes, substantial amount of time will be taken to back up the data blocks stored in the solid state drive 2200. According to some embodiments of the inventive concept, the controller 1110 separately records only updated part of updated data blocks among data blocks (i.e., hot data blocks) stored in the solid state drive 2200 in a log region of the solid state drive 2200. The mapping management part 1112 indicates to a flag of logical block corresponding to the updated data block that the data block is changed.

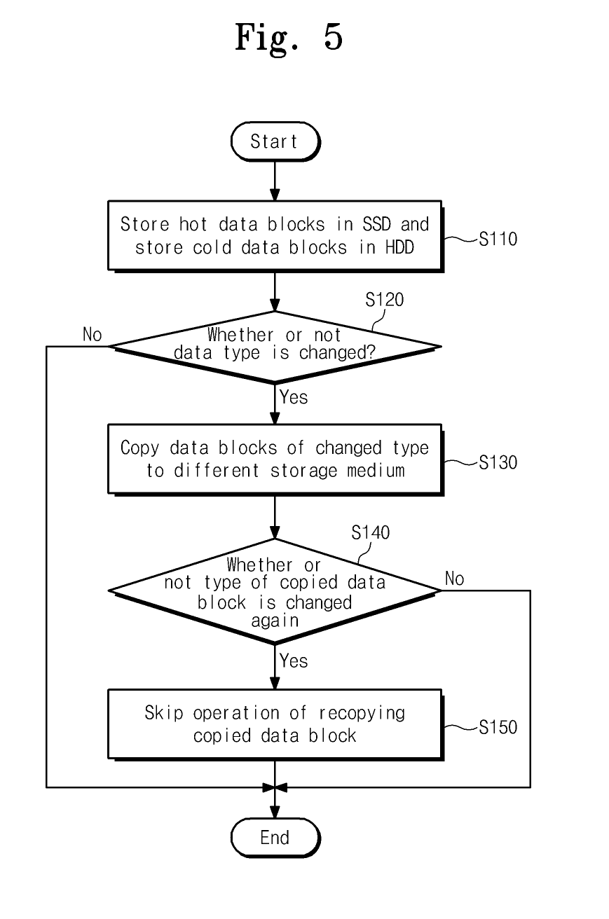

FIG. 4 is a drawing illustrating a solid state drive 2200 and a hard disk drive 2300.

Referring to FIG. 4, the solid state drive 2200 includes a meta area 2210, a new write cache area 2220, a hot data area 2230 and a logging area 2240. The meta area 2210 of the solid state drive 2200 stores meta information needed to manage the solid state drive 2200 and data stored in the solid state drive 2200. The new write cache area 2220 is an area which is reserved for new data block storage. A write request for new data block is performed by storing the data block in the solid state drive 2200. The hot data area 2230 stores hot data blocks (e.g., updated data blocks). The logging area 2240 stores an updated part of updated data blocks among the data blocks stored in the solid state drive 2200. The logging area 2240 stores an updated part of data blocks updated in the solid state drive 2200 among data blocks doubly stored in the solid state drive 2200 and the hard disk drive 2300.

The hard disk drive 2300 includes a meta area 2310, a cold data area 2320 and a logging area 2240. The meta area 2310 of the hard disk drive 2300 stores meta information needed to manage the hard disk drive 2300 and data stored in the hard disk drive 2300. The cold data area 2320 stores cold data blocks. The logging area 2330 is an area for storing data of the logging area 2240 of the solid state drive 2200. When a power supply is cut off, data of the logging area 2240 of the solid state drive 2200 will be stored (copied) in the logging area 2330 of the hard disk drive 2300.

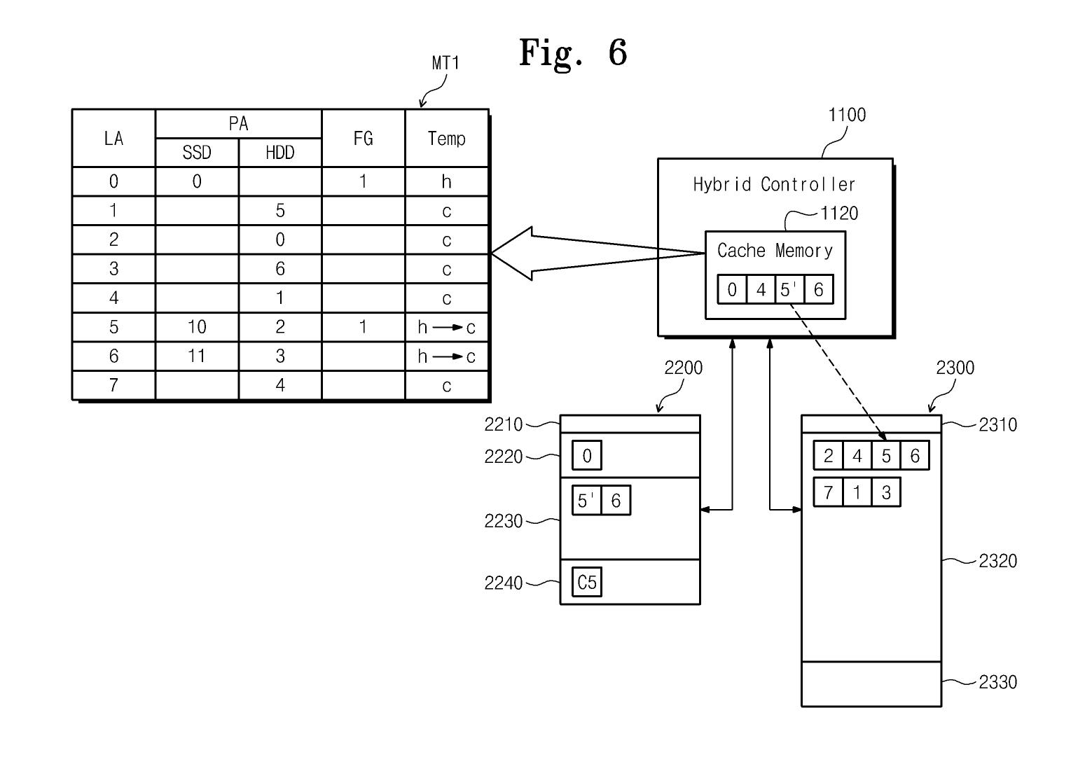

FIG. 5 is a flow chart illustrating an operation method of hybrid storage device 2000 in accordance with some embodiments of the inventive concept. Referring to FIGS. 2 and 5, in S110, the solid state drive 2200 stores hot data blocks and the hard disk drive 2300 stores cold data blocks. In S120, the hybrid controller 1100 distinguishes whether types of data blocks stored in the hybrid storage device 2000 are changed or not with reference to the mapping table MT. According to a distinguishment result, S130 is selectively performed.

In the S130, the hybrid controller 1100 copies data block having changed type to a different storage media. If a type of data block stored in the hard disk drive 2300 is changed to hot data, the hybrid controller 1100 stores a corresponding data block in the solid state drive 2200. Consequently, the hybrid controller 1100 controls the two storage media so that hot data blocks are stored in the solid state drive 2200 and cold data blocks are stored in the hard disk drive 2300.

In S140, the hybrid controller 1100 continuously monitors the mapping table MT to distinguish whether a type of copied data block is changed again or not. According to a distinguishment result, S150 is selectively performed.

In the S150, if a type of copied data block is changed again, the hybrid controller 1100 skips a recopy operation of the copied data block.

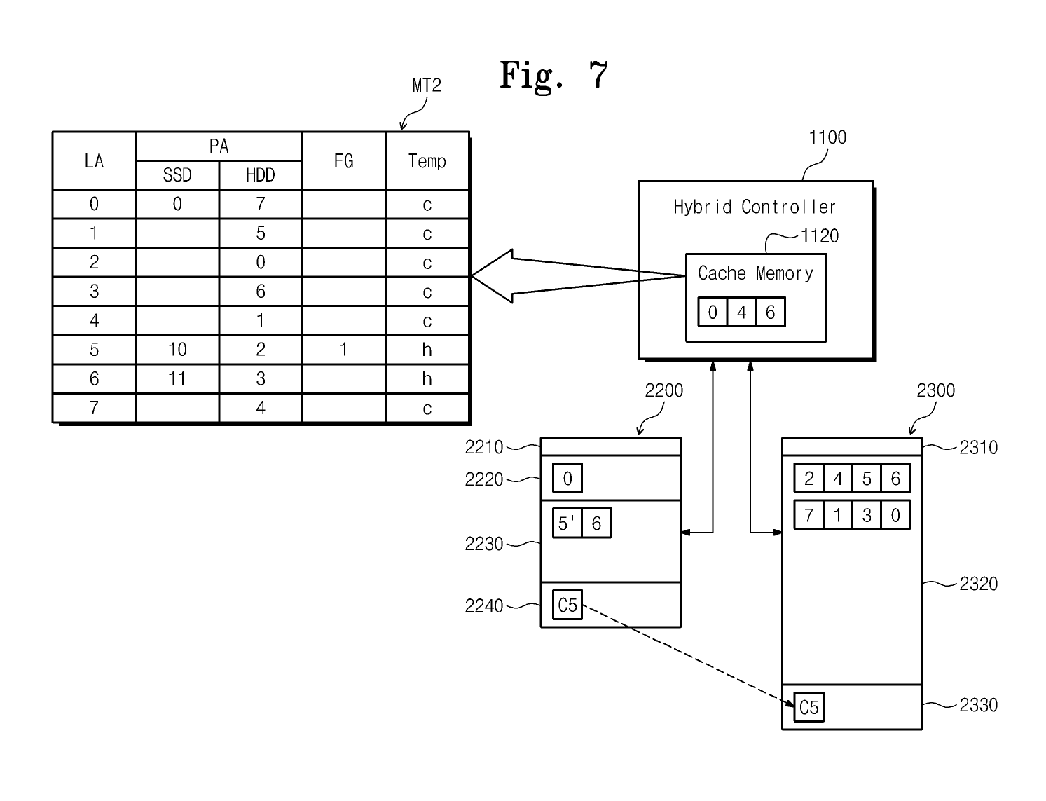

FIGS. 6 and 7 are drawings for explaining an operation method of hybrid storage device 2000.

Referring to FIGS. 2 and 6, a mapping table MT1 includes a logical block field LA, a physical block field PA and a temperature field Temp.

In the mapping table MT1, a physical block of the solid state drive 2200 and a physical block of the hard disk drive 2300 are mapped to each of the zeroth through seventh logical blocks LA0˜LA7. For example, a eleventh physical block of the solid state drive 2200 and a third physical block of the hard disk drive 2300 are mapped to the sixth logical block LA6. It is distinguished from the mapping table MT1 that data block corresponding to the sixth logical block LA6 is doubly stored in the solid state drive 2200 and the hard disk drive 2300. A zeroth physical block of the solid state drive 2200 is mapped to the zeroth logical block LA0 and a physical block of the hard disk drive 2300 is not mapped to the zeroth logical LA0. It is distinguished from the mapping table MT1 that a data block corresponding to the zeroth logical block LA0 is stored in only the solid state drive 2200 and is not stored in the hard disk drive 2300.

The mapping table MT1 includes a flag field (FG) for distinguishing whether data block stored in the solid state drive 2200 is updated or not. From the mapping table MT1, it is distinguished that data blocks corresponding to logical blocks (LA0, LA5) having a flag value “1” are updated.

Numbers expressed in the cache memory 1120, the solid state drive 2200 and the hard disk drive 2300 mean a logical block of data block stored in each of them.

Assume that data block (hereinafter it is referred to as fifth data block) corresponding to the fifth logical block (LA5) and data block (hereinafter it is referred to as sixth data block) corresponding to the sixth logical block (LA6) are changed from a hot data block to a cold data block.

The hybrid controller 1100 in accordance with some embodiments of the inventive concept distinguishes on the basis of the mapping table MT1 whether corresponding data blocks are doubly stored in the solid state drive 2200 and the hard disk drive 2300. According to the mapping table MT1 of FIG. 6, the fifth and sixth data blocks are doubly stored in the solid state drive 2200 and the hard disk drive 2300.

The hybrid controller 1100 distinguishes on the basis of the mapping table MT1 whether the duplicate data blocks are updated in the solid state drive 2200. The update operation includes receiving an updated data block from a host and updating data block stored in the solid state drive 2200 by the received updated data block. In FIG. 6, the updated fifth data block (it is expressed by 5′) is stored in the solid state drive 2200.

According to the flag field (FG) of the mapping table MT1, it is distinguished that the sixth data block is not updated and the fifth data block is updated. Thus, an operation of moving the sixth data block to the hard disk drive 2300 may be omitted. An operation of moving the fifth data block to the hard disk drive 2300 may be performed.

After that, the hybrid controller 1100 distinguished whether the updated data block is stored in the cache memory 1120 or not. If the updated data block is stored in the cache memory 1120, the hybrid controller 1100 stores the updated data block in the hard disk drive 2300 from the cache memory 1120. In FIG. 6, the updated fifth data block in the cache memory 1120 is stored in the hard disk drive 2300.

If the updated data block is not stored in the cache memory 1120, the hybrid controller 1100 reads an updated part C5 of the fifth data block from the logging area 2240 of the solid state drive 2200. The hybrid controller 1100 stores the read updated part C5 of the fifth data block in the logging area 2330 of the hard disk drive 2300. Thus, the updated fifth data block can be restored on the basis of the fifth data block and the updated part C5 of the fifth data block that are stored in the hard disk drive 2300.

Referring to FIGS. 2 and 7, a data block (hereinafter it is referred to as zeroth data block) corresponding to zeroth logical block is stored in the new write cache area 2220. A sixth data block and an updated fifth data block are stored in the hot data area 2230 of the solid state drive 2200. The updated part C5 of the fifth data block is stored in the logging area 2240 of the solid state drive 2200.

Assume that a power supply being supplied to the hybrid storage device 2000 is cut off. If the batteries included in the hybrid storage device 2000 are all consumed, data stored in the solid state drive 2200 will be lost.

The hybrid controller 1100 distinguishes on the basis of a mapping table MT2 whether data blocks stored in the solid state drive 2200 are doubly stored in the solid state drive 2200 and the hard disk drive 2300. If so, the hybrid controller 1100 distinguishes on the basis of a flag field (FG) of the mapping table MT2 whether each of the data blocks doubly stored is updated. Referring to the mapping table MT2 of FIG. 7, a data block (hereinafter it is referred to as zeroth data block) corresponding to zeroth logical block LA0 and fifth and sixth data blocks are stored in the solid state drive 2200. The zeroth, fifth and sixth data blocks are doubly stored in the two storage media. The fifth data block is updated and the zeroth and sixth data blocks are not updated. Thus, it is not required that the zeroth and sixth data blocks are copied to the hard disk drive 2300. Since the fifth data block is updated, it is required that the updated fifth data block is stored in the hard disk drive 2300.

After that, the hybrid controller 1100 distinguishes whether the updated data block is stored in the cache memory 1120 or not. If the updated data block is stored in the cache memory 1120, the hybrid controller 1100 stores the updated data block in the hard disk drive 2300 from the cache memory 1120. If the updated data block is not stored in the cache memory 1120, the hybrid controller 1100 reads the updated data part C5 from the logging area 2240 of the solid state drive 2200. The hybrid controller 1100 stores the read data C5 in the logging area 2330 of the hard disk drive 2300.

In FIG. 7, the hybrid controller 1100 reads only the updated part C5 of the fifth data block from the logging area 2240 of the solid state drive 2200 and stores the read data C5 in the logging area 2330 of the hard disk drive 2300. Thus, when a power is turned on, the updated fifth data block can be restored on the basis of the fifth data block and the updated part C5 of the fifth data block that are stored in the hard disk drive 2300.

According to some embodiments of the inventive concept, the solid state drive 2200 providing a high speed operation can effectively process requirements for reading and writing the hot data block.

According to some embodiments of the inventive concept, a hybrid storage device maintaining an I/O characteristic of high performance is provided.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A hybrid storage device comprising:
first and second storage media in which a plurality of data blocks having a data type of hot data or cold data is stored according to the data type; and
a hybrid controller which is configured to copy the data block having a changed data type to the first storage medium if the data type of the data block stored in the second storage medium is changed,
wherein when the data type of the data block copied to the first storage medium is changed again and the data block copied to the first storage medium is not updated, the hybrid controller is configured to skip an operation that the copied data block is recopied to the second storage medium.

2. The hybrid storage device of claim 1, wherein the first storage medium is a solid state drive and the second storage medium is a hard disk drive.

3. The hybrid storage device of claim 1, wherein the first storage medium is a hard disk drive and the second storage medium is a solid state drive.

4. The hybrid storage device of claim 1, wherein the hybrid controller comprises a cache memory which is configured to store a mapping table including mapping information between logical blocks of the plurality of data blocks and physical blocks of the plurality of the data blocks,
wherein the mapping table comprises information of first physical block indicating a storage location of the data block having the changed data type among the second storage medium and information of second physical block indicating a storage location of the copied data block among the first storage medium.

5. The hybrid storage device of claim 4, wherein the hybrid controller is configured to skip an operation of recopying the copied data block when the mapping table includes the information of the first and second physical blocks and the first physical block is not updated.

6. The hybrid storage device of claim 1, wherein when receiving an updated data block from the outside, the hybrid controller is configured to update the data block copied to the first storage medium to the updated data block.

7. The hybrid storage device of claim 6, wherein the hybrid controller comprises a cache memory operating as a buffer memory between the outside and the first and second storage media, and wherein if the updated data block remains in the cache memory, the hybrid controller is configured to store the updated data block stored in the cache memory in the second storage medium when the data type of data block copied to the first storage medium is changed again.

8. The hybrid storage device of claim 6, wherein the hybrid controller is configured to store a updated data part between the copied data block and the updated data block in the first storage medium.

9. The hybrid storage device of claim 8, wherein in the case that the data block copied to the first storage medium is updated, if the data type of the copied data block is changed again, the hybrid controller is configured to store the updated data part in the second storage medium.

10. The hybrid storage device of claim 6, wherein the hybrid controller comprises a cache memory, and wherein the hybrid controller is configured to store flag information for distinguishing whether each of the data blocks stored in the first storage medium is updated or not in the cache memory.

11. An operation method of hybrid storage device including first and second storage media comprising:
storing a plurality of data blocks in the first and second storage media according to data types of the plurality of data blocks; and
copying data block of changed data type to the first storage medium if the data type of data block stored in the second storage medium is changed,
wherein when the data type of data block copied to the first storage medium is changed again and the data block copied to the first storage medium is not updated, an operation that the copied data block is recopied to the second storage medium is omitted.

12. The operation method of claim 11, wherein the data block of changed data type is maintained at the second storage medium.

13. The operation method of claim 11, further comprising:
receiving updated data block from the outside;
updating the data block copied to the first storage medium to the updated data block; and
storing updated data part between the copied data block and the updated data block in the first storage medium.

14. The operation method of claim 13, wherein the hybrid storage device comprises a cache memory operating as a buffer memory between the outside and the first and second storage media, further comprising:
if the updated data block remains in the cache memory, when the data type of copied data block is changed again, storing the updated data block stored in the cache memory in the second storage medium.

15. The operation method of claim 13, further comprising:
when the data type of data block copied to the first storage medium is changed again, storing the updated data part in the second storage medium.
